(19) United States
(12) Patent Application Publication
(10) Pub. No.: US 2026/0089279 A1
(43) Pub. Date: Mar. 26, 2026

(54) STORAGE MEDIUM STORING PROGRAM SUPPORTING GENERAL-PURPOSE SCANNING SOFTWARE, INFORMATION PROCESSING METHOD, AND INFORMATION PROCESSING APPARATUS

(71) Applicant: CANON KABUSHIKI KAISHA, Tokyo (JP)

(72) Inventor: DAISUKE NAGAO, Saitama (JP)

(21) Appl. No.: 19/334,335

(22) Filed: Sep. 19, 2025

(30) Foreign Application Priority Data
Sep. 26, 2024 (JP) 2024-167863

(51) Int. Cl. H04N 1/00

(52) U.S. Cl. CPC H04N 1/00806; H04N 1/00824; H04N 1/00938; H04N 1/00811

(57) ABSTRACT

A non-transitory computer-readable storage medium storing an application program that causes an information processing apparatus to perform a control method, the application program being configured to cooperate with general-purpose scanning software commonly usable with image reading devices provided by a plurality of manufacturers, and the control method includes displaying an object for receiving a setting related to a type of a document to be read, and outputting an instruction for reading the document to an image reading device, the instruction being based on the setting received via the object.

### BACKGROUND

### Field of the Technology

The present disclosure relates to a storage medium storing a program supporting general-purpose scanning software, an information processing method, and an information processing apparatus.

### Description of the Related Art

A technique for issuing a reading instruction to a scanning device connected to a host computer by using a scanner driver installed in a host computer as software for controlling the scanning device has been known. An operating system (OS) as basic software is installed in the host computer, and the scanner driver is configured according to specifications specified by the OS, so that the scanner driver operates by being called from the OS. A vendor (maker) who provides a scanning device can provide a method for issuing a reading instruction to the scanning device through an OS by providing a scanner driver conforming to the specification specified by the OS.

In recent years, a standard class driver (hereinafter, also called “standard driver”) commonly usable by scanning devices provided by a plurality of vendors has been provided in Windows®. The above-described standard driver is included in a package of the OS, and can easily be used when an optional scanning device is connected to a host computer. Therefore, convenience of the user is increased because the user does not have to separately install a model-specific scanner driver appropriate for the scanning device. Further, it is assumed that the standard driver can specify a scanning function according to scanning function information generated based on information acquired from the connected scanning device. Therefore, the user who uses the standard driver can specify a scanning function according to capability of the connected scanning device, even though the user uses the single standard driver. However, functions the user can specify are limited to functions implemented by only the standard driver, and the user cannot specify functions unique to a vendor (maker) of the scanning device.

Therefore, Japanese Patent Laid-Open No. 2021-033526 describes a program for extending a printing function of general-purpose software.

Herein, a document type setting is provided as a function of a scanner driver unique to a scanner vendor.

The document type setting is a function which allows the user to specify whether a document mainly consists of text or pictures. Text included in a scanned image is sharpened when the user selects “Text”, and pictures included in a scanned image are sharpened when “Picture” is selected. By using the above-described function, the user can appropriately scan a document by selecting a document type according its content.

While the document type setting is typical available through vendor-specific driver, it may not be accessible when using the standard driver.

### SUMMARY

According to an aspect of the present disclosure, a non-transitory computer-readable storage medium storing an application program that causes an information processing apparatus to perform a control method, the application program being configured to cooperate with general-purpose scanning software commonly usable with image reading devices provided by a plurality of manufacturers, and the control method includes displaying an object for receiving a setting related to a type of a document to be read, and outputting an instruction for reading the document to an image reading device, the instruction being based on the setting received via the object.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating hardware configuration of a scanning system according to a present embodiment.

FIGS. 2A and 2B are block diagrams illustrating software configuration of the scanning system according to the present embodiment.

FIGS. 3A to 3C are diagrams illustrating a scan setting screen and a detailed setting screen according to a first embodiment.

FIG. 4 is a flowchart illustrating scanning function information editing processing executed by an extension application according to the first embodiment.

FIG. 5 is a diagram illustrating lists of scanning functions implemented by respective devices according to the first embodiment.

FIG. 6 is a sequence diagram illustrating scanning processing according to the first embodiment.

FIG. 7 is a flowchart illustrating scanning processing executed by the extension application according to the first embodiment.

FIG. 8 is a flowchart illustrating scanning processing executed by a scanning device according to the first embodiment.

FIG. 9 is a flowchart illustrating processing for adding a document type function executed by an extension application according to a second embodiment.

FIG. 10 is a sequence diagram illustrating scanning processing according to the second embodiment.

FIG. 11 is a flowchart illustrating scanning processing executed by the extension application according to the second embodiment.

FIG. 12 is a sequence diagram illustrating scanning processing according to a third embodiment.

FIG. 13 is a sequence diagram illustrating scanning processing according to the third embodiment.

FIG. 14 is a sequence diagram illustrating scanning processing according to a fourth embodiment.

FIG. 15 is a flowchart illustrating scanning processing executed by an extension application according to the fourth embodiment.

### DESCRIPTION OF THE EMBODIMENTS

Hereinafter, embodiments according to the present disclosure are described in detail with reference to the appended drawings. The embodiments described hereinafter are not intended to limit the content of the present disclosure described in the appended claims, and not all of the combinations of features described in the embodiments are essentially required as the solutions of the present disclosure.

### First Embodiment

### Hardware Configuration of Scanning System

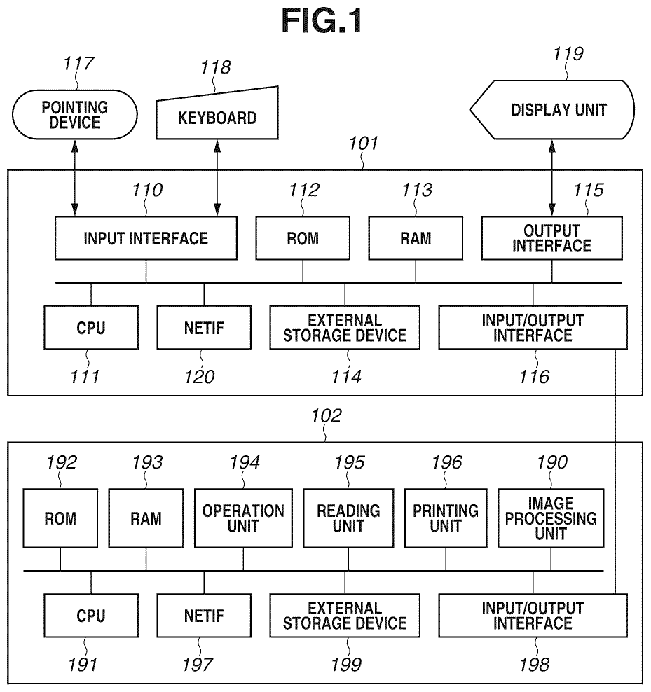

FIG. 1 is a block diagram illustrating hardware configuration of a scanning system.

### (Host Computer)

In FIG. 1, a host computer 101 is one example of the information processing apparatus. The host computer 101 includes an input interface 110, a central processing unit (CPU) 111, a read only memory (ROM) 112, a random-access memory (RAM) 113, an external storage device 114, an output interface 115, and an input/output interface 116. Input devices such as a keyboard 118 and a pointing device 117 are connected to the input interface 110, and a display device such as a display unit 119 is connected to the output interface 115. NETIF 120 is a network interface which executes control for transmitting and receiving data to/from an external device via a network.

The ROM 112 stores an initialization program.

For example, the external storage device 114 is a hard disk drive (HDD) or a solid-state drive (SSD). The external storage device 114 stores a group of application programs, an operating system (OS), as well as various types of data.

The RAM 113 is used as a working memory when various programs stored in the external storage device 114 are executed, so that the various programs can operate in the host computer 101.

In the present embodiment, the CPU 111 executes processing according to a program code stored in the ROM 112 to execute the functions and processing illustrated in the flowcharts implemented by the host computer 101.

### (Scanning Device)

The scanning device 102 operating as a device is one example of the image reading device. The scanning device 102 is connected to the host computer 101 via an input/output interface 198 of the scanning device 102 and the input/output interface 116 of the host computer 101. The input/output interface 198 of the scanning device 102 and the input/output interface 116 of the host computer 101 can be connected to each other via a wired network or a wireless network.

The scanning device 102 operating as an image reading device includes a CPU 191, a ROM 192, a RAM 193, an operation unit 194, a reading unit 195, a printing unit 196, an NETIF 197, an input/output interface 198, and an external storage device 199.

The CPU 191 generally controls the scanning device 102.

The ROM 192 is a memory which stores programs.

The RAM 193 is a memory which temporarily stores programs and image data.

The reading unit 195 is a scanner which reads a document image.

The printing unit 196 prints an image on a sheet based on image data. In addition, the printing unit 196 is not essentially required.

The NETIF 197 is a network interface which executes control for transmitting and receiving data to/from an external device via a network.

The image processing unit 190 executes various types of image editing processing on image data input to the image processing unit 190.

In the present embodiment, the host computer 101 and the scanning device 102 are provided separately. However, the host computer 101 and the scanning device 102 may be provided as one information processing apparatus. Further, a reading setting screen and a detailed setting screen described below are displayed on the display unit 119. In the present embodiment, an electrophotographic digital multifunction peripheral having a plurality of functions, such as a copying function, a printing function, and a facsimile function, is described as an example of the scanning device 102. However, the scanning device 102 is not limited to the above, and the present embodiment is applicable to a device employing another processing method such as an ink jet method and a scanner only reading images. Further, the host computer 101 can be a desktop personal computer, a smartphone, or a notebook personal computer.

### (Software Configuration of Scanning System)

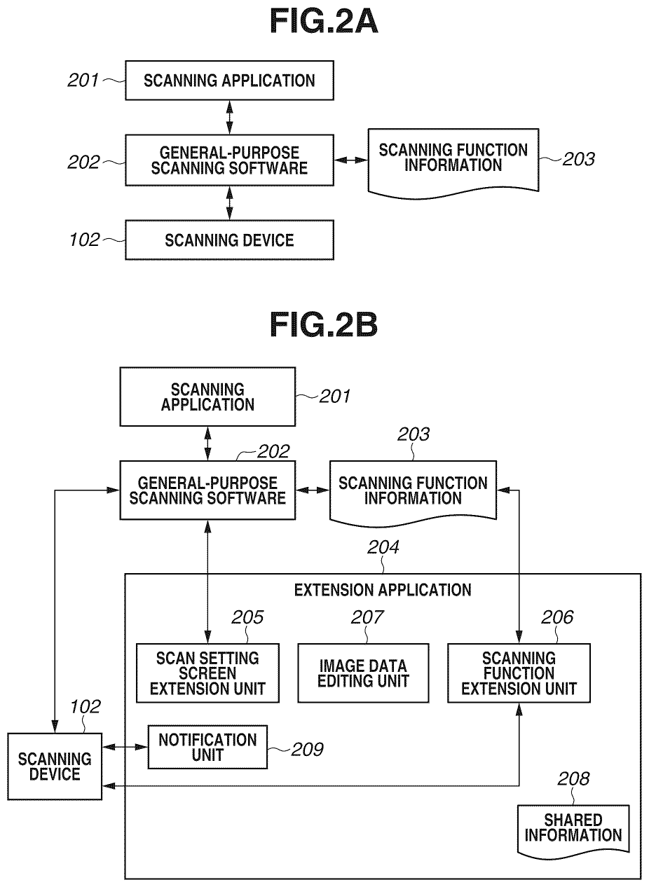

FIGS. 2A and 2B are diagrams schematically illustrating software configuration of the scanning system. The software configuration illustrated in FIGS. 2A and 2B is stored in the external storage device 114 in FIG. 1. Herein, the software configuration is described based on the condition that the scanning system uses the host computer 101 with the Microsoft (R) Windows (R) 11 Operating System. In addition, the present technique can also be applied to a standard driver provided by Apple MacOS.

FIG. 2A illustrates a general configuration where an extension application 204 is not associated with the general-purpose scanning software 202 and the scanning device 102.

FIG. 2B illustrates a configuration where the extension application 204 is associated with the general-purpose scanning software 202 and the scanning device 102.

### (Software Configuration of Scanning System (Without Association of Extension Application))

First, a configuration of the scanning system in a case where the extension application 204 is not associated is described.

A scanning application 201 is software for obtaining scanned content (image data). For example, a document preparation application and an image editing application correspond to the scanning application 201. The scanning application 201 receives a scanning request from a user, and issues a scanning instruction to the OS. The scanning instruction includes scan setting information for instructing the operation performed by the general-purpose scanning software 202 and the scanning device 102.

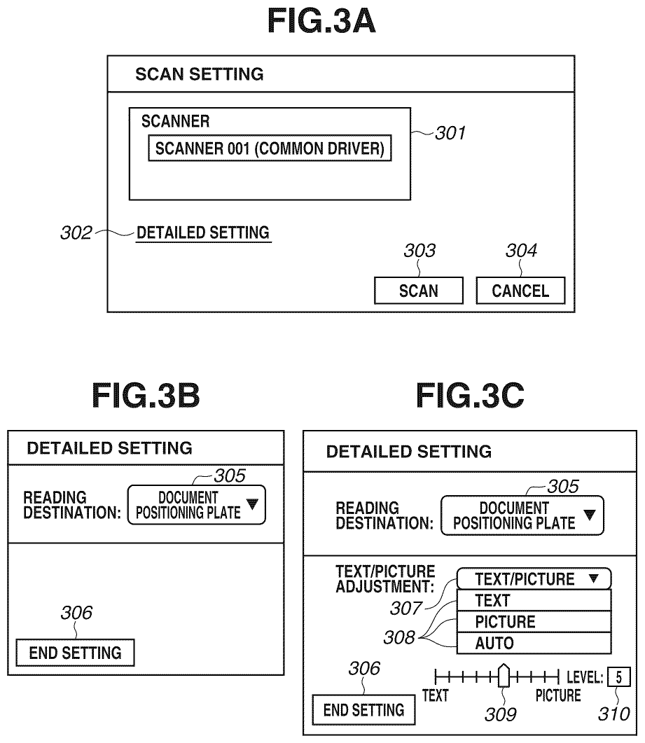

In order to execute the scanning instruction, the scanning application 201 can display a scan setting screen provided by any of the general-purpose scanning software 202, the OS, and the scanning application 201. Further, when a detailed setting button displayed on the scan setting screen is pressed, the general-purpose scanning software 202 additionally displays a detailed setting screen. The scan setting screen and the detailed setting screen are described below with reference to FIGS. 3A to 3C. According to the scanning function information (settable information) of the general-purpose scanning software 202, the detailed setting screen includes setting items (hereinafter, also called “control items”) indicating settable scanning functions and control items indicating setting values of the settable scanning functions. Based on the scanning function information 203, the general-purpose scanning software 202 determines a scanning capability.

The scanning function information 203 is data describing scanning functions, and all of settable scanning functions, setting values of the settable scanning functions, and an exclusive relationship between the setting values are described in the scanning function information 203. The scanning function information 203 is included in a configuration file of the general-purpose scanning software 202, and arranged in the external storage device 114 as an unchangeable file. Alternatively, the scanning function information 203 can dynamically be generated by the general-purpose scanning software 202. Specifically, the general-purpose scanning software 202 or the OS acquires attribute data of the scanning device 102 from the scanning device 102, and can generate the scanning function information 203 according to attribute information described in the acquired attribute data. In a case where the scanning function information 203 is generated dynamically, the generated scanning function information 203 can be edited. The attribute data of the scanning device 102 acquired from the scanning device 102 includes attribute information describing a scanning function which can be specified by the scanning device 102 (i.e., capability of the scanning device 102) and a setting value related to the attribute information. This information is stored in the RAM 113.

With the above-described configuration, the user is allowed to specify a scanning function usable by the scanning device 102 through the general-purpose scanning software 202, depending on the connected scanning device 102. In other words, even in a case where a scanning device having different functions or a scanning device developed by a different vendor is connected to the host computer 101, the user is allowed to specify a usable scanning function through the general-purpose scanning software 202, depending on the connected scanning device. Further, the general-purpose scanning software 202 can generate a scanning instruction which can be interpreted by a plurality of scanning devices provided by different vendors, and can output the scanning instruction to the plurality of scanning devices provided by different vendors. In addition, the vendor can be a maker (i.e., manufacturer) of the scanning device 102. Herein, a standard class driver called “Mopria”, which executes scanning based on a standard scanning protocol, is described as the general-purpose scanning software 202. The general-purpose scanning software 202 acquires capability information of the connected scanning device 102 and generates the scanning function information 203 based on the acquired information, in order to allow the user to specify a scanning function supported by the connected scanning device 102. The general-purpose scanning software 202 acquires the scanning function information 203 from the scanning device 102 and receives image data which the scanning device 102 has generated by scanning a document, through Internet Printing Protocol (IPP). This general-purpose scanning software 202 does not support a document type function. This is because the document type function is a function unique to a vendor of the scanning device 102 (a maker of the scanning device 102).

### (Document Type Function)

The document type function is a function which allows the user to specify whether to sharpen a text portion or a picture portion of the document. Image data with sharp text and emphasized edges can be generated when the user scans a document by setting “Text” through the document type function, and smooth image data can be generated when the user selects “Picture”, so that the user can acquire optional image data.

The user can set adjustment levels of Text and Picture through the document type function. In the present embodiment, a method for setting an adjustment level in a range of ten adjustment levels is described as an example. However, a setting method of the document type function is not limited to the example. A setting range can be wider or narrower than the above-described range.

(Software Configuration of Scanning System (with Association of Extension Application))

Next, with reference to FIG. 3B, a configuration of the scanning system in a case where the extension application 204 is associated is described. Descriptions of the configuration similar to the configuration illustrated in FIG. 2B are omitted.

The extension application 204 is software for supporting the general-purpose scanning software 202, and is also called a support application. The extension application 204 is software which is not previously included in (or supplied together with) the OS. Accordingly, the user has to operate the host computer 101 to download the extension application 204 from a server via the internet, and to install the extension application 204. Alternatively, the extension application 204 may automatically be installed when the scanning device 102 is connected to the host computer 101. Specifically, in a case where the scanning device 102 is connected to the host computer 101, the OS acquires device identification information from the scanning device 102. The OS may download the extension application 204 corresponding to the acquired device identification information from the server via the internet and install the extension application 204. In other words, the general-purpose scanning software 202 and the extension application 204 are stored in the host computer 101 as different files.

Although the general-purpose scanning software 202 and the extension application 204 may be updated or upgraded, the update processing is executed at different timings. In other words, the general-purpose scanning software 202 and the extension application 204 are acquired by the host computer 101 at different timings. Further, a trigger for causing the host computer 101 to acquire the general-purpose scanning software 202 is different from a trigger for causing the host computer 101 to acquire the extension application 204. In a case where the extension application 204 is installed, the OS associates the extension application 204 with the general-purpose scanning software 202 and the scanning device 102.

The extension application 204 described in the present embodiment includes a scan setting screen extension unit 205, a scanning function extension unit 206, an image data editing unit 207, and a notification unit 209. The extension application 204 further includes shared information 208 commonly accessible from the respective units. Actually, the shared information 208 is a file stored in the external storage device 114 or information stored in the RAM 113. The extension application 204 writes or reads information to/from the shared information 208 by using an application program interface (API) provided by the OS.

In addition, the extension application 204 may end the operation every time the processing executed by respective units is ended. In this case, the OS activates the extension application 204 every time the request for using the unit is received.

Further, the extension application 204 may cancel the processing being executed by the unit. In a case where the processing is cancelled, a job that is in process is deleted by the OS.

The scanning application 201 receives a scanning request from the user, and issues a scanning instruction to the OS. Similar to the configuration illustrated in FIG. 2A, in the present configuration, the scanning application 201 can display a scan setting screen. In the present configuration, a detailed setting screen provided by the extension application 204 is displayed. Specifically, the detailed setting screen provided by the scan setting screen extension unit 205 included in the extension application 204 is displayed. Further, the scan setting screen extension unit 205 can save the detailed setting set by the user in the shared information 208.

The extension application 204 includes the image data editing unit 207. The image data editing unit 207 acquires image data from the scanning device 102 and edits the acquired image data. The image data editing unit 207 acquires detailed setting information from the shared information 208, and executes image editing on the image data according to the detailed setting. The extension application 204 may acquire image data acquired by the general-purpose scanning software 202 and execute image editing on the image data according to the detailed setting.

Further, there is a case where the user does not perform a document type setting in the configuration illustrated in FIG. 2B. In this case, similar to the configuration illustrated in FIG. 2A, the general-purpose scanning software 202 may directly issue a scanning request instruction to the scanning device 102 instead of issuing the instruction via the extension application 204.

The extension application 204 includes the scanning function extension unit 206. The scanning function extension unit 206 can edit the scanning function information 203 generated by the general-purpose scanning software 202 or the OS. With this configuration, the scanning function extension unit 206 can add the function provided by the extension application 204. Further, the scanning function extension unit 206 can add a function, such as the document type function, supported by the scanning device 102 but not supported by the general-purpose scanning software 202, can add an exclusive relationship between the setting values of the scanning functions, and can perform other operations. The OS activates the scanning function extension unit 206 when the extension application 204 is initially associated with the scanning device 102 and the general-purpose scanning software 202. The OS may further activate the scanning function extension unit 206 at another timing such as a timing when the OS is activated.

The extension application 204 also includes the notification unit 209. The notification unit 209 can display a notification to the user in response to occurrence of an error in the scanning device 102. For example, when a reading jam error occurs in the scanning device 102, the general-purpose scanning software 202 detects the occurrence of the reading jam error, and the OS displays a message on the display unit 119 by using a notification function as one function of the OS, called a toast notification. When the user presses the toast notification, the notification unit 209 of the extension application 204 is called by the OS, and a user interface (UI) screen of the notification unit 209 is displayed. For example, a message describing details of a scanning jam error and a jam clearance method can be displayed on the UI screen of the notification unit 209.

Further, a configuration of the extension application 204 realizing the present embodiment does not always have to include all of the above-described functions (units), and may include only one or some of the functions, or may include other functions. In addition, the extension application 204 may simply be called a scanning software.

As described above, the extension application 204 includes at least any one of the following functions.
1. A function for displaying a setting screen (scan setting screen extension unit 205)
2. A function for editing image data according to a detailed setting (image data editing unit 207)
3. A function for supporting a function which can be specified by image data generation software (scanning function extension unit 206)
4. A function for displaying a screen in response to occurrence of an error in the scanning device 102 (notification unit 209)

### (Setting Screen)

Next, examples of the scan setting screen and the detailed setting screen according to the present embodiment are described with reference to FIGS. 3A to 3C. FIG. 3A illustrates a scan setting screen displayed by the scanning application 201. FIG. 3B illustrates a detailed setting screen displayed when the extension application 204 is not present as illustrated in FIG. 2A. FIG. 3C illustrates a detailed setting screen displayed when the extension application 204 is present as illustrated in FIG. 2B.

In addition, the units and the modules for displaying the scan setting screen are not limited to the above.

For example, the scan setting screen extension unit 205 may generate only a display screen. In this case, the scan setting screen extension unit 205 transmits the generated display screen to the scanning application 201 via the general-purpose scanning software 202. Then, the scanning application 201 may display the acquired display screen.

### <Scan Setting Screen (Scanning Application)>

First, a scan setting screen illustrated in FIG. 3A, displayed by the scanning application 201 is described.

A control 301 includes an object for allowing the user to set a scanner used to scan image data (i.e., a scanner used to read image data).

A control 302 is a detailed setting button. When the control 302 is pressed, an additional scanning screen is displayed by the general-purpose scanning software 202 or the scan setting screen extension unit 205.

A control 303 is a scanning start button, and a control 304 is a scanning cancel button.

### <Detailed Setting Screen (General-Purpose Scanning Software)>

Next, FIG. 3B is described. FIG. 3B illustrates a setting screen additionally displayed by the general-purpose scanning software 202 when the extension application 204 is not present.

A control 305 allows the user to select a reading destination. In FIG. 3B, a document positioning plate is selected as a reading destination.

A control 306 is a setting end button. When the control 306 is pressed, this setting screen is brought back to the scan setting screen in FIG. 3A.

### <Scan Setting Screen (Scan Setting Screen Extension Unit)>

Next, FIG. 3C is described. FIG. 3C illustrates a setting screen additionally displayed by the scan setting screen extension unit 205 when the extension application 204 is present. Unlike the setting screen in FIG. 3B, a control 307, a list 308, and a control 309 are additionally displayed on the setting screen.

The control 307 is a button (object) by which the user can select a setting for a document type. In FIG. 3C, “Text/Picture” is selected.

The list 308 indicating a setting value of the document type is displayed when the control 307 is pressed.

The list 308 includes “Text”, “Picture”, and “Auto”, in addition to “Text/Picture”, which is currently selected. “Text/Picture” allows the user to manually set a level indicating whether the document is more like a text document or a picture document. The user can adjust the level by moving the bar-shaped control 309 of the object left or right.

A level 310 displays a level indicating the degree to which the document resembles text or picture content, as set by the user when the user has selected “Text/Picture” from the list 308. In the following embodiment, the operation executed when “Text/Picture” is selected from the list 308 is described. In a case where “Text” is selected, the operation to be executed is similar to the operation executed when “Level 1” of “Text/Picture”, a level indicating the document is nearly a text document, is selected. Further, in a case where “Picture” is selected, the operation is similar to that executed when “Level 10” of “Text/Picture”, a level indicating the document is nearly a picture document, is selected. Furthermore, in a case where “Auto” is selected, the operation to be executed is similar to the operation executed when “Level 5”, a central level indicating the document is intermediate between a text document and a picture document, is selected. Alternatively, the level may automatically be adjusted according to a ratio of a text portion to a picture portion of the scanned document.

For example, in a case where a percentage of a text portion in the document is 20 percent whereas a percentage of a picture portion is 80 percent, a level may automatically be set to Level 8. Further, in the present embodiment, although a bar is used to set a text/picture ratio, a value may directly be input, or may be input via a button for selecting a value. Alternatively, icons representing “Text” and “Picture” may be displayed and selected. Further, in a case where an item other than “Text/Picture” is selected from the list 308, the bar-shaped control 309 used to adjust the intermediate level may be hidden. Alternatively, the bar-shaped control 309 for adjusting a level may be displayed in an immobilized state. Further, the bar-shaped control 309 brought into an immobilized state may be displayed in gray, so that the user can clearly understand the immobilized state. Further, in a case where Level 1 is set in a state where “Text/Picture” is set to the control 307, “Text/Picture” may be changed to “Text”. Similarly, in a case where Level 10 is set in a state where “Text/Picture” is set to the control 307, “Text/Picture” may be changed to “Picture”. Furthermore, the bar-shaped control 309 may always be in a changeable state, and “Text/Picture” may be set to the control 307 when any one of Level 2 to Level 9 is selected. The UI configuration for changing the document type is not limited to the examples described above and may be implemented in various ways.

Herein, a reason for the difference in scan setting items between FIGS. 3B and 3C is described. The detailed setting screen is generated with reference to a scanning capability generated based on the scanning function information 203.

However, the document type function cannot be added to the scanning function information 203 because the general-purpose scanning software 202 does not support the document type function. Further, even if the document type function is primarily included in the scanning function information 203, the general-purpose scanning software 202 cannot interpret the document type function included in the scanning function information 203. Accordingly, it is not possible to display a document type setting on the detailed setting screen. However, the document type function is added to the scanning function information 203 by the scanning function extension unit 206, and the scan setting screen extension unit 205 displays the detailed setting screen with reference to the scanning capability. Through the above-described configuration, the extension application 204 can display the document type function on the detailed setting screen. In addition, extended functions other than the document type function may additionally be included in the setting screen in FIG. 3C.

### [Editing Processing of Scanning Function Information: Scanning Function Extension Unit]

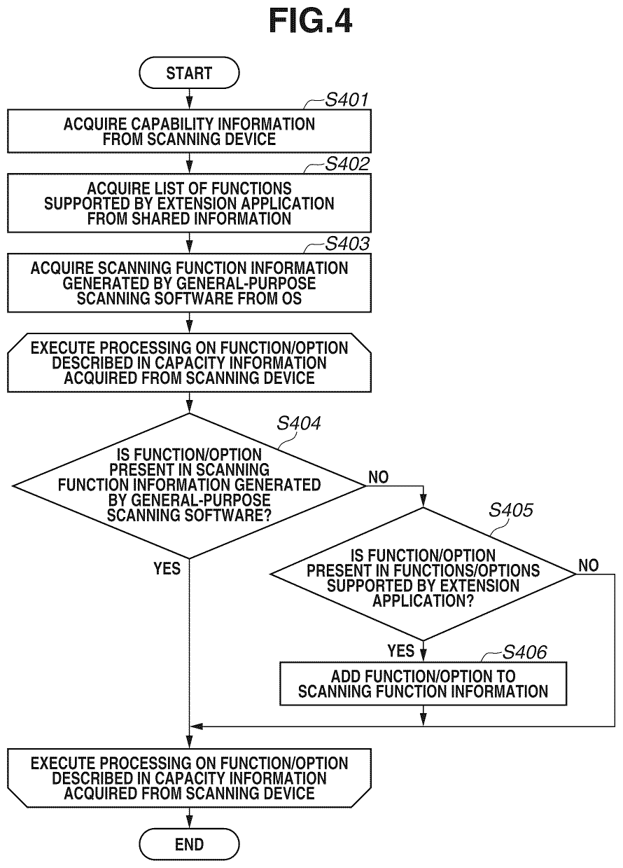

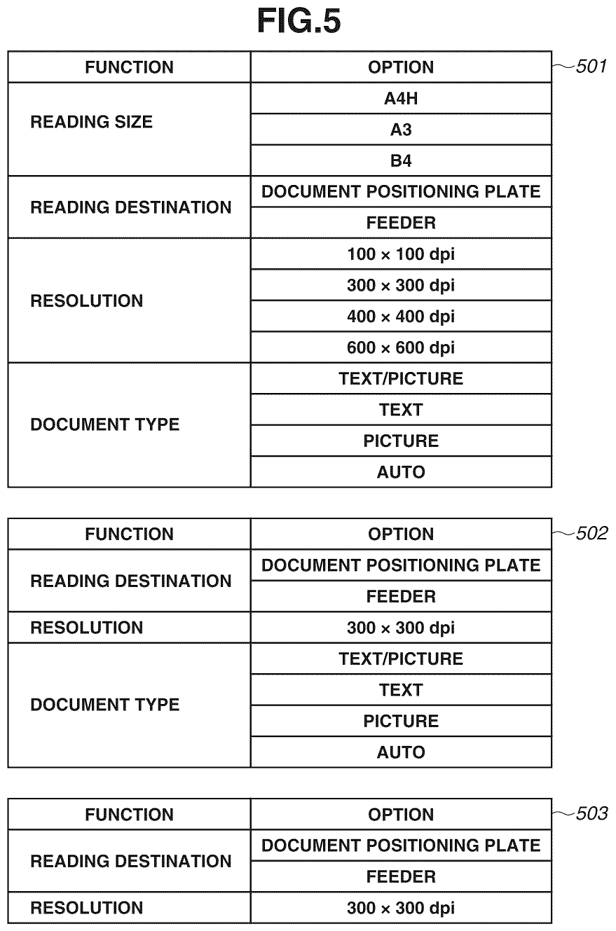

The processing flow for editing the scanning function information 203 by the scanning function extension unit 206 is described with reference to FIGS. 4 and 5. Each step is implemented by the CPU 111 by executing each of the units read to the RAM 113 from the external storage device 114.

In step S401, the scanning function extension unit 206 acquires capability information from the scanning device 102 serving as an image reading device. The capability information describes attribute information indicating a function which can be specified by the scanning device 102 and a setting value related to the attribute information.

Table 501 in FIG. 5 illustrates an example of a list of capability information acquired from the scanning device 102. As illustrated in the table 501, a function such as a reading size specification function and an option which can be set to the function can be acquired from the scanning device 102.

In step S402, the scanning function extension unit 206 acquires a list of scanning functions supported by the extension application 204 from the shared information 208. The list of scanning functions supported by the extension application 204 is stored in the shared information 208, and all of scanning functions that can be processed by the extension application 204 and setting values of the scanning functions are described in the list. Table 502 in FIG. 5 illustrates an example of a list of scanning functions supported by the extension application 204. The list of scanning functions supported by the extension application 204 may be updated when the extension application 204 is updated.

In step S403, the scanning function extension unit 206 acquires the scanning function information 203 created by the general-purpose scanning software 202 from the OS. Table 503 in FIG. 5 illustrates an example of a list of scanning functions supported by the general-purpose scanning software 202. The scanning function information 203 created by the general-purpose scanning software 202 is created based on the capability information described in the table 501 of FIG. 5, acquired from the scanning device 102. From among the capability information acquired from the scanning device 102, only the scanning functions supported by the general-purpose scanning software 202 are described in the scanning function information 203 created by the general-purpose scanning software 202. Accordingly, functions described in this scanning function information 203 are limited. For example, although the document type function is included in the capability information described in the table 501 of FIG. 5 acquired from the scanning device 102, the general-purpose scanning software 202 does not support the document type function. Therefore, the document type function is not described in the scanning function information 203. Because the scanning function extension unit 206 adds a function and an option to the scanning function information 203, the extension application 204 can compensate for the limitations of functions provided by the general-purpose scanning software 202.

The scanning function extension unit 206 can also delete unnecessary functions and options from the scanning function information 203 created by the general-purpose scanning software 202.

The processing in steps S404, S405, and S406 is repeatedly executed with respect to the list of functions described in the capability information acquired from the scanning device 102 in step S401. In the present embodiment, the processing is repeatedly executed with respect to the thirteen items described in the table 501, i.e., “Reading Size: A4H” to “Document Type: Auto”.

In step S404, the scanning function extension unit 206 determines whether a function/option which is being currently processed is present in the scanning function information 203 generated by the general-purpose scanning software 202. In a case where the function/option which is being processed is present in the scanning function information 203 (YES in step S404), the processing returns to the start of the loop. Specifically, the scanning function extension unit 206 selects a next item from the functions/options described in the scanning function information 203 acquired from the scanning device 102, and executes the processing in step S404. In a case where the last item of the functions/options described in the capability information acquired from the scanning device 102 is being processed, the scanning function extension unit 206 exits the loop and completes the processing illustrated in the flowchart in FIG. 4. In a case where the function/option which is being processed is not present in the scanning function information 203 (NO in step S404), the processing proceeds to step S405. In the present embodiment, for example, a scanning function supported by the scanning device 102, “Reading Destination: Document Positioning Plate”, described in the table 501, is also present in the table 503 which describes the scanning functions supported by the general-purpose scanning software 202. Therefore, a determination result in step S404 is “YES”. On the other hand, because “Reading Size: A4H” described in the table 501 is not present in the table 503, a determination result in step S404 is “NO”. Therefore, the processing proceeds to step S405.

In step S405, the scanning function extension unit 206 determines whether the currently processed function/option is present in the functions/options supported by the extension application 204. In a case where the function/option which is being processed is present (YES in step S405), the processing proceeds to step S406. In a case where the function/option which is being processed is not present (NO in step S405), the scanning function extension unit 206 either executes the processing in step S404 again, or leaves the loop and ends the processing illustrated in this flowchart similarly to the case where a determination result in step S404 is “YES”. In the present embodiment, in a case where the function which is being processed is “Document Type: Text/Picture”, for example, a determination result in step S405 is “YES” because this function is also present in the table 502 which describes the scanning functions supported by the extension application 204. Therefore, the processing proceeds to step S406.

In step S406, the scanning function extension unit 206 adds the function/option which is being processed to the scanning function information 203. After the processing in step S406, the scanning function extension unit 206 either executes the processing in step S404 again, or leaves the loop and ends the processing illustrated in this flowchart similarly to the case where a determination result in step S404 is “YES”.

As described above, the scanning function extension unit 206 adds the function/option which is not supported by the general-purpose scanning software 202 but supported by the scanning device 102 and the extension application 204 to the scanning function information 203. The scanning capability is generated based on the scanning function information 203 edited by the above-described processing. Further, the scan setting screen extension unit 205 generates a display screen based on the generated scanning capability. Therefore, the function which is not supported by the general-purpose scanning software 202 can be extended and displayed on the detailed setting screen illustrated in FIG. 3C.

### (Scanning Processing Sequence)

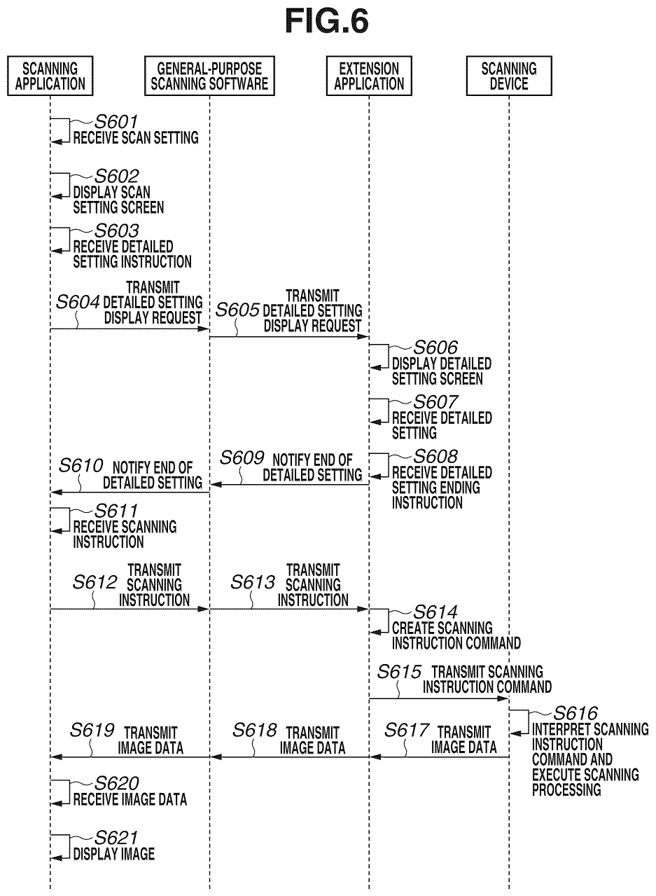

Next, the processing sequence executed by the scanning application 201, the general-purpose scanning software 202, the extension application 204, and the scanning device 102 after receiving the scan setting by the scanning application 201 is described with reference to FIG. 6. The processing in the respective steps in FIG. 6, except for the processing executed by the scanning device 102, is implemented by the CPU 111 by executing the scanning application 201, the general-purpose scanning software 202, and the extension application 204 read to the RAM 113 from the external storage device 114. The processing in respective steps executed by the scanning device 102 in FIG. 6 is implemented by the CPU 191 of the scanning device 102, by reading a program stored in the ROM 192 or the external storage device 199 into the RAM 193 and executing the program.

In step S601, the scanning application 201 receives a scan setting from the user.

The user can issue a scan setting instruction to the scanning application 201 by operating the pointing device 117 and the keyboard 118.

In step S602, the scanning application 201 displays the scan setting screen illustrated in FIG. 3A on the display unit 119.

In step S603, the scanning application 201 receives a detailed setting instruction. The user can issue a detailed setting instruction by selecting the control 302 by operating the pointing device 117 and the keyboard 118.

In step S604, the scanning application 201 transmits a detailed setting display request to the general-purpose scanning software 202.

In step S605, the general-purpose scanning software 202 transmits a detailed setting display request to the extension application 204. As described above, in the configuration illustrated in FIG. 2B, the general-purpose scanning software 202 displays the detailed setting screen in FIG. 3C.

In step S606, the scan setting screen extension unit 205 of the extension application 204 displays the detailed setting screen in FIG. 3C on the display unit 119. This is because the document type function has been added to the scanning function information 203 by the scanning function extension unit 206 as described in FIG. 4. The scan setting screen extension unit 205 displays the detailed setting screen in FIG. 3C on the display unit 119 with reference to the scanning capability generated based on the scanning function information 203 additionally including the document type function. In the present embodiment, a resolution supported by the extension application 204 is only one type, 300×300 dpi. Therefore, the resolution is not displayed on the detailed setting screen because the user does not have to select a resolution. However, even if the resolution cannot be selected, the resolution may be displayed on the detailed setting screen and explicitly provided to the user.

In step S607, the scan setting screen extension unit 205 receives a detailed setting. In the present embodiment, it is assumed that the user selects “Reading Destination: Document Positioning Plate”, and “Document Type: Text/Picture”, as illustrated in FIG. 3C. The CPU 111 stores the received setting in the RAM 113.

In step S608, the scan setting screen extension unit 205 receives information indicating the end of detailed setting, and instructs the extension application 204 to write the received setting in the scan setting information. The user can issue a detailed setting ending instruction by selecting the control 306 by operating the pointing device 117 or the keyboard 118. When the setting is written in the scan setting information, an item such as a resolution which is not selected by the user may also be written together.

In step S609, the extension application 204 transmits a notification indicating the end of detailed setting to the general-purpose scanning software 202.

In step S610, the general-purpose scanning software 202 transmits the notification indicating the end of detailed setting to the scanning application 201.

In step S611, the scanning application 201 receives a scanning instruction. The user can issue a scanning instruction by selecting the control 303 by operating the pointing device 117 and the keyboard 118.

In step S612, the scanning application 201 issues a scanning instruction to the general-purpose scanning software 202.

In step S613, the general-purpose scanning software 202 issues a scanning instruction to the extension application 204.

In step S614, the extension application 204 creates a scanning instruction command based on the scan setting information written in step S608. In a case where an item not selected by the user, such as a resolution, is not written in the scan setting information in step S608, the extension application 204 may add the item when the scanning instruction command is created in step S614. Alternatively, the extension application 204 may create the scanning instruction command without adding the item, so that scanning processing is executed by the scanning device 102 at a default value.

In step S615, the extension application 204 instructs the scanning device 102 to execute scanning processing by transmitting the scanning instruction command.

In step S616, the scanning device 102 interprets the scanning instruction command and executes scanning processing.

According to the scanning instruction, the scanning device 102 executes necessary image processing on image data when scanning processing is executed.

In the present embodiment, in a case where the scan setting “Document Type: Text/Picture” in FIG. 3C is set, image data is generated through the scanning processing executed at a level 310 of “Text/Picture” set by the bar-shaped control 309.

In step S617, the scanning device 102 transmits the generated image data to the extension application 204.

In step S618, the extension application 204 transmits the received image data to the general-purpose scanning software 202.

In step S619, the general-purpose scanning software 202 transmits the received image data to the scanning application 201.

In step S620, the scanning application 201 receives the image data.

In step S621, the scanning application 201 displays the received image data and ends the processing.

### [Scanning Processing: Extension Application]

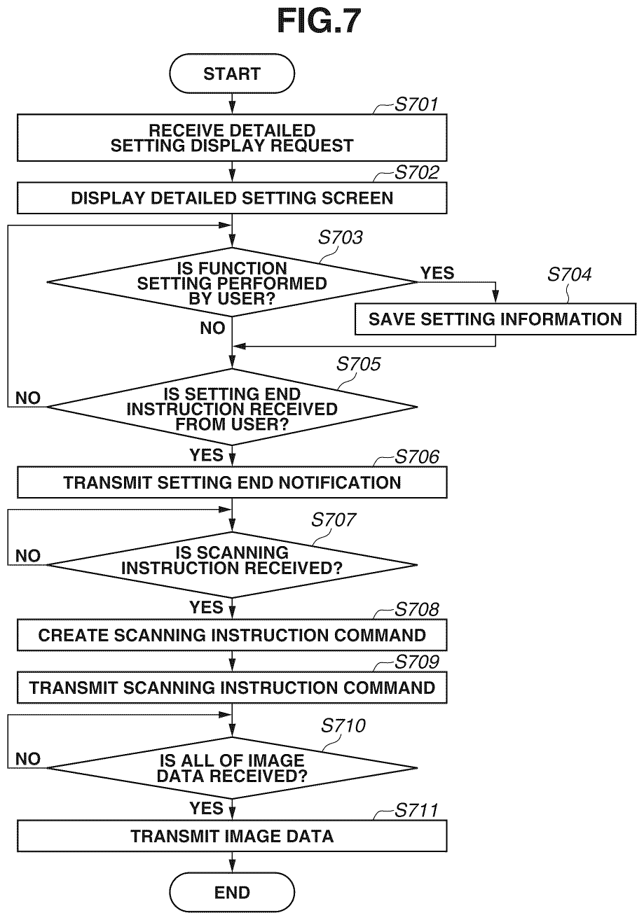

Scanning processing executed by the extension application 204 is described with reference to FIG. 7. Each step is implemented by the CPU 111 by executing each of the units read into the RAM 113 from the external storage device 114.

In step S701, the extension application 204 receives a detailed setting display request.

In step S702, the scan setting screen extension unit 205 of the extension application 204 displays the detailed setting screen in FIG. 3C on the display unit 119. This is because the document type function has been added to the scanning function information 203 by the scanning function extension unit 206 as described in FIG. 4. The scan setting screen extension unit 205 displays the detailed setting screen in FIG. 3C on the display unit 119 with reference to the scanning capability generated based on the scanning function information 203 additionally including the document type function.

In step S703, the scan setting screen extension unit 205 determines whether a function setting is performed by the user. In a case where a function setting is performed by the user (YES in step S703), the CPU 111 advances the processing to step S704. In a case where a function setting is not performed by the user (NO in step S703), the CPU 111 advances the processing to step S705.

In step S704, the CPU 111 receives the detailed setting, stores the received detailed setting in the RAM 113, and advances the processing to step S705.

In step S705, the scan setting screen extension unit 205 determines whether a setting end instruction is received from the user. In a case where the setting end instruction is received (YES in step S705), the CPU 111 is notified of the end of detailed setting, writes the received setting in the scan setting information, and advances the processing to step S706. In a case where the setting end instruction is not issued (NO in step S705), the processing returns to step S703. Then, the scan setting screen extension unit 205 determines whether a function setting is received from the user again.

In step S706, the extension application 204 transmits a notification indicating the end of detailed setting to the general-purpose scanning software 202.

In step S707, the extension application 204 determines whether a scanning instruction is received from the general-purpose scanning software 202. In a case where a scanning instruction is received (YES in step S707), the CPU 111 advances the processing to step S708. In a case where a scanning instruction is not received (NO in step S707), the processing returns to step S707, so that the extension application 204 determines whether a scanning instruction is received from the general-purpose scanning software 202 again.

In step S708, the extension application 204 creates a scanning instruction command based on the scan setting information written in step S705.

As a method for creating the scanning instruction command in step S708, there is a method for extending a command of a standard protocol. As an extension method, first, there is a method for describing a dedicated command in a command extension area of the standard protocol. There are also a method for adding a proprietary command to a trailing end of the command of the standard protocol, and a method for overwriting the command of the standard protocol with a command system unique to the extension application 204.

Further, in a case where an instruction is issued from the extension application 204, the extension application 204 may issue an instruction and execute communication based on a protocol unique to a vendor (maker), different from the standard protocol.

In step S709, the extension application 204 instructs the scanning device 102 to execute scanning processing by transmitting the scanning instruction command.

In step S710, the extension application 204 determines whether all of image data is received from the scanning device 102. In a case where all image data is received (YES in step S710), the CPU 111 advances the processing to step S711. In a case where not all of image data is received (NO in step S710), the processing returns to step S710, so that the extension application 204 determines whether all of image data is received from the scanning device 102.

In step S711, the extension application 204 transmits the received image data to the general-purpose scanning software 202, and ends the processing.

### [Scanning Processing: Scanning Device]

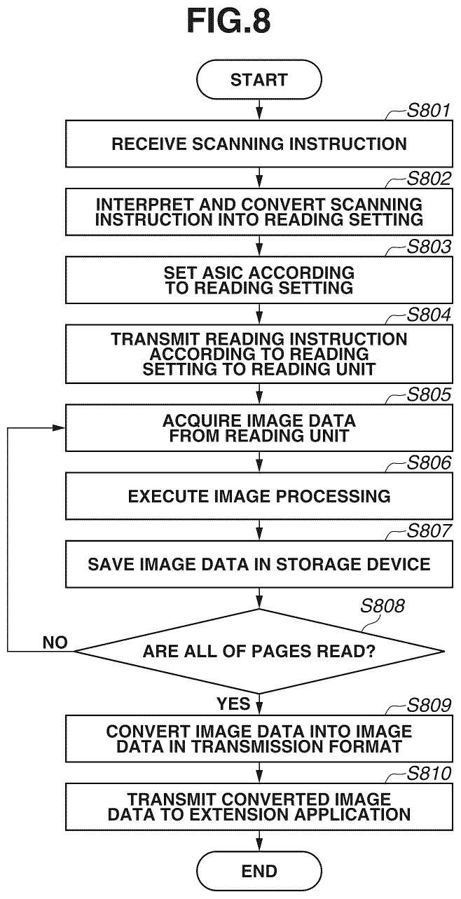

Next, scanning processing executed by the scanning device 102 when the scanning device 102 receives a scanning instruction from the extension application 204 is described with reference to FIG. 8. Processing in each step, illustrated in the flowchart in FIG. 8, is implemented by the CPU 191 by executing a program stored in the ROM 192.

In step S801, the CPU 191 receives a scanning instruction transmitted from the extension application 204.

In step S802, the CPU 191 analyzes the scanning instruction received in step S801, and converts the scanning instruction into a reading setting which the scanning device 102 can execute reading processing. In the present embodiment, “Document Positioning Plate”, “Document Type: Text/Picture”, and “Resolution: 300×300 dpi” are set as the reading setting.

In step S803, according to the reading setting converted in step S802, the CPU 191 determines an application specific integrated circuit (ASIC) of the image processing unit 190 used for executing scanning processing, and executes setting on the ASIC.

In step S804, the CPU 191 transmits a reading instruction according to the reading setting to the reading unit 195. In the present embodiment, the CPU 191 transmits an instruction to read a document placed on a document positioning plate.

In step S805, the CPU 191 acquires image data from the reading unit 195.

In step S806, the CPU 191 and the image processing unit 190 execute image processing on the received image data.

In the present embodiment, the scanning device 102 executes conversion of a resolution into 300×300 dpi and executes document type processing. Through the document type function, the scanning device 102 analyzes and appropriately adjusts the image data to the level 310 of Text/Picture by using the ASIC set in step S803. In a case where the reading unit 195 can read the image data at 300×300 dpi, the reading unit 195 may acquire the image data at 300×300 dpi. In this case, the image processing for converting the resolution does not have to be implemented in step S806.

In step S807, the CPU 191 stores the image data in the external storage device 199.

In step S808, the CPU 191 determines whether scanning processing of all of pages is ended. In a case where the CPU 191 determines that the scanning processing is not ended (NO in step S808), the CPU 191 advances the processing to step S805 and executes the scanning processing on the next page. In a case where the CPU 191 determines that the scanning processing is ended (YES in step S808), the CPU 191 advances the processing to step S809.

In step S809, the CPU 191 and the image processing unit 190 convert the image data stored in step S807 according to a transmission format setting received in step S801. In the present embodiment, the transmission format is not included in the scanning instruction received from the extension application 204. For this reason, the image data is converted to JPEG, i.e., a default format of the scanning device 102. However, the transmission format is not limited to the above, and the image data can be converted into image data of any format processible by the information processing apparatus.

In step S810, the converted image data is transmitted to the extension application 204, so that all of the processing is ended.

As described above, in the present embodiment, the scan setting screen extension unit 205 of the extension application 204 modifies the scanning function information 203 based on the capability information of the general-purpose scanning software 202, the extension application 204, and the scanning device 102. Further, when a detailed setting screen is requested from the user, the setting screen is displayed based on the scanning capability generated from the scanning function information 203. Accordingly, the user is allowed to adjust the levels of text and pictures. Thereafter, when the scanning device 102 receives a scanning instruction which reflects the adjusted levels of text and pictures, the scanning device 102 executes reading at the levels of text and pictures specified by the level 310. Through the above-described processing, the scanning device 102 can implement the document type function, so that it is possible to provide the document type function to the user.

The present embodiment is described based on the configuration illustrated in FIG. 2B with reference to the detailed setting screen in FIG. 3C. However, the present disclosure is not limited to the example. For example, in step S604, in a case where the general-purpose scanning software 202 receives a detailed setting display request, the general-purpose scanning software 202 may display the detailed setting screen illustrated in FIG. 3B. After the detailed setting in FIG. 3B is ended, the general-purpose scanning software 202 may request the extension application 204 to display the additional detailed setting screen. Then, the extension application 204 may additionally display a detailed setting screen on which a document type can be set.

Further, although a scanning instruction is issued to the extension application 204 from the general-purpose scanning software 202, the configuration is not limited to the example. For example, a scanning instruction may be issued to the extension application 204 from the scanning application 201. Further, a control used to issue a scanning instruction may be arranged on the detailed setting screen, so that an instruction is directly issued to the extension application 204 from the user. Further, image data may directly be transmitted to the scanning application 201 from the extension application 204 instead of being transmitted via the general-purpose scanning software 202, or image data may be transmitted to the scanning application 201 from the scanning device 102. Furthermore, received image data may be stored in the external storage device 114, and only information about a file path as a storage destination may be transmitted.

Further, in the present embodiment, image data is transmitted after receiving all of image data when a plurality of pieces of image data is present. However, the image data may be transmitted when received.

### Second Embodiment

Hereinafter, a second embodiment of the present disclosure is described. In the above-described first embodiment, the scanning device 102 firstly interprets the scan setting information including the document type function, and executes scanning processing according to the specified document type setting.

However, depending on a scanning device, processing may not be executed according to a document type. In such a case, even if the extension application 204 supports the document type function and can generate the scan setting information including a document type setting, the scanning device cannot execute processing according to a document type.

Accordingly, in the present embodiment, feasibility of the document type function is determined based on the capability information of the scanning device 102. In a case where the scanning device 102 can implement the document type function, the scan setting information including the document type setting specified by the user is generated and transmitted to the scanning device 102. On the other hand, in a case where the scanning device 102 cannot implement the document type function, the scan setting information excluding the document type setting is generated and transmitted to the scanning device 102. Thereafter, the extension application 204 implements the document type function with respect to the image data read by the scanning device 102. In this way, even if the scanning device 102 does not support the document type function, image data according to the document type can be provided to the user.

Hereinafter, only a difference between the first embodiment and the present embodiment is described.

It is assumed that the scanning device 102 is a scanning device which does not support the document type function. A configuration of the extension application 204 is different from the configuration of the extension application 204 in the first embodiment. The scanning function extension unit 206 adds the document type setting to the scanning function information 203 in a case where a unit for executing processing for adjusting a document type of the image data is present in the extension application 204.

In other words, even in a case where the document type function is not present in the capability information acquired from the scanning device 102, the document type setting is added to the scanning function information 203. Accordingly, the user can use the document type function. Based on the level 310 of the document type function set by the user, the image data editing unit 207 executes processing for adjusting a document type of the image data received from the scanning device 102. The processing is described below in detail.

### [Editing Processing of Scanning Function Information: Scanning Function Extension Unit]

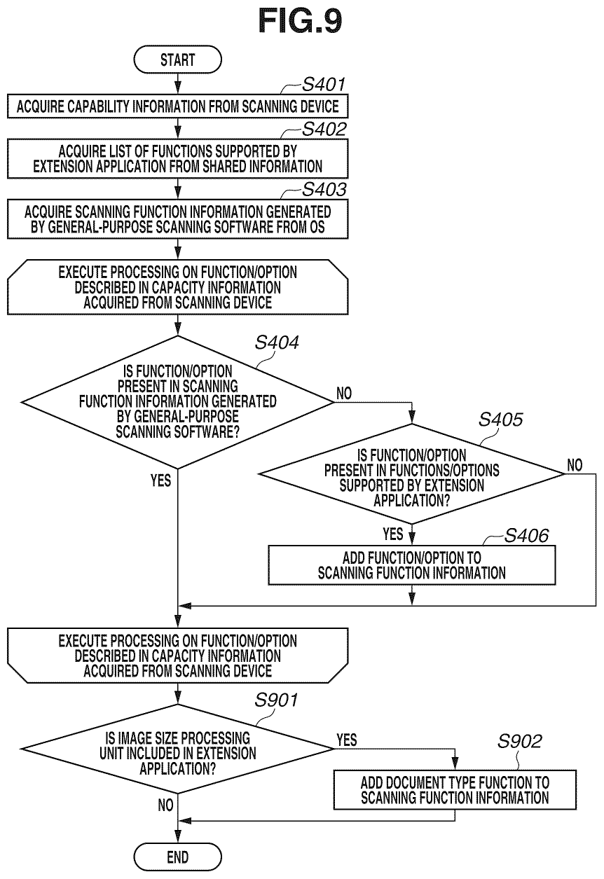

Editing processing of scanning function information executed by the scanning function extension unit 206 according to the present embodiment is described with reference to FIG. 9. The same reference numeral is applied to a step common to the step described in FIG. 4, and description thereof is omitted. Further, a point different from the processing illustrated in FIG. 4 is mainly described. Each step in FIG. 9 is implemented by the CPU 111 by executing each of the units read to the RAM 113 from the external storage device 114.

When the scanning function extension unit 206 ends the repetitive processing in steps S404 to S406, the processing proceeds to step S901. Herein, the scanning device 102 does not support the document type function. For this reason, after the processing in steps S404 to S406 is ended, the document type function is not added to the scanning function information 203.

Accordingly, although the function is not described in the capability information returned from the scanning device 102, in steps S901 and S902, the scanning function extension unit 206 executes processing to add the function to the scanning function information 203 according to a module included in the extension application 204.

Specifically, in step S901, the scanning function extension unit 206 refers to the capability information of the scanning device 102 described in the table 501 in FIG. 5 and the scanning function information 203, and determines whether a module for executing processing for adjusting a document type is present in the extension application 204. In a case where the scanning function extension unit 206 determines that a module for executing processing for adjusting a document type is present (YES in step S901), the processing proceeds to step S902. In a case where the scanning function extension unit 206 determines that a module for executing processing for adjusting a document type is not present (NO in step S901), this processing is ended. In the present embodiment, the processing for adjusting a document type can be executed by the image data editing unit 207 included in the extension application 204. For this reason, the scanning function extension unit 206 determines that a module for executing processing for adjusting a document type is present in the extension application 204.

In step S902, the scanning function extension unit 206 adds the document type function and ends the processing.

As described above, the scanning function extension unit 206 adds the function/option which is not supported by the general-purpose scanning software 202 but supported by the scanning device 102 and the extension application 204 to the scanning function information 203. Thereafter, the scanning function extension unit 206 determines whether the extension application 204 can execute processing for adjusting a document type, and adds a function for adjusting a document type to the scanning function information 203 in a case where it is possible to execute the processing for adjusting a document type. Through the above-described processing, even in a case where the function for adjusting a document type is not supported by the scanning device 102, a display screen is generated by the scan setting screen extension unit 205 based on the scanning function information 203. Therefore, it is possible to display the detailed setting screens illustrated in FIGS. 3A to 3C.

### (Scanning Processing Sequence)

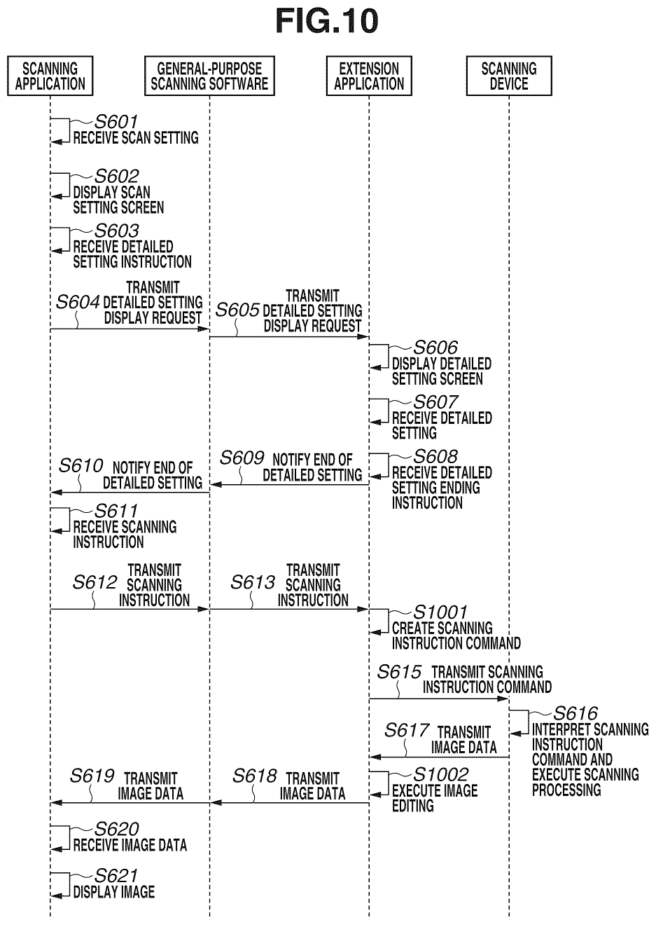

Next, processing sequence executed by the scanning application 201, the general-purpose scanning software 202, the extension application 204, and the scanning device 102 after the scan setting is received by the scanning application 201 is described with reference to FIG. 10. The processing in respective steps in FIG. 10, except for the processing executed by the scanning device 102, is implemented by the CPU 111 by executing the scanning application 201, the general-purpose scanning software 202, and the extension application 204 read to the RAM 113 from the external storage device 114. The processing in respective steps executed by the scanning device 102 in FIG. 10 is implemented by the CPU 191 of the scanning device 102, by reading a program stored in the ROM 192 or the external storage device 199 to the RAM 193 and executing the program. The same reference numeral is applied to a step common to the step described in FIG. 6, and description thereof is omitted. Further, a point different from the processing illustrated in FIG. 6 is mainly described.

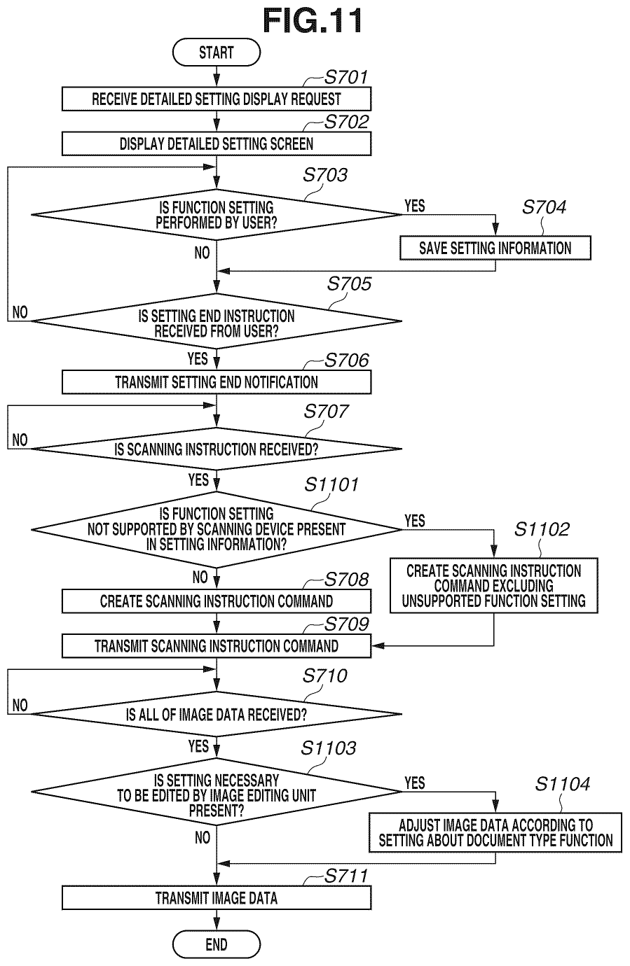

In step S1001, the extension application 204 creates a reading instruction command. Details of the processing in step S1001 is described with reference to the flowchart in FIG. 11.

In step S1002, the image data editing unit 207 executes image processing to adjust a document type of the received image data. In the present embodiment, adjustment similar to the adjustment described in the first embodiment is executed on the image data.

Scanning processing executed by the extension application 204 is described with reference to FIG. 11. The same reference numeral is applied to a step common to the step described in FIG. 7, and description thereof is omitted. Further, a point different from the processing illustrated in FIG. 7 is mainly described. Each step is implemented by the CPU 111 by executing each of the units read to the RAM 113 from the external storage device 114.

### [Scanning Processing: Extension Application]

In step S1101, the extension application 204 acquires the capability information of the scanning device 102 from the shared information 208. In a case where the capability information of the scanning device 102 is not present, the scanning function extension unit 206 may request the capability information from the scanning device 102 and store the capability information in the shared information 208.

Based on the acquired capability information and setting information, the extension application 204 determines whether a function setting not supported by the scanning device 102 is present.

In a case where the extension application 204 determines that a function not supported by the scanning device 102 is set (YES in step S1101), the CPU 111 advances the processing to step S1102. In the present embodiment, because the function for adjusting a document type which is not supported by the scanning device 102 is set, the processing proceeds to step S1102. In a case where the extension application 204 determines that a function not supported by the scanning device 102 is not set (NO in step S1101), the CPU 111 advances the processing to step S708.

In step S1102, the extension application 204 creates a scanning instruction command excluding the unsupported function setting. Then, the processing proceeds to step S707. In the present embodiment, the function for adjusting a document type is excluded from the scanning instruction command.

Next, processing to be executed when receipt of all of image data is determined in step S710 is described.

In step S1103, based on the setting information, the extension application 204 determines whether a setting necessary to be edited by the image data editing unit 207 is present. In a case where the setting necessary to be edited is present (YES in step S1103), the CPU 111 advances the processing to step S1104. In the present embodiment, because the function for adjusting a document type which cannot be executed by the scanning device 102 is set, the processing proceeds to step S1104.

On the other hand, in a case where the setting necessary to be edited is not present (NO in step S1103), the CPU 111 advances the processing to step S711.

Next, in step S1104, similar to the first embodiment, the image data editing unit 207 adjusts the received image data according to the document type based on the function for adjusting a document type set in step S703.

In the present embodiment, a function setting not supported by the scanning device 102 is excluded from the scanning instruction command. However, even if the function setting is described in the scanning instruction command, the scanning device 102 cannot execute the function because the scanning device 102 cannot interpret the unsupported instruction command.

For this reason, the unsupported function may be described without being excluded from the scanning instruction command.

As described above, according to the present embodiment, it is possible to provide the document type function to the user even in a case where the document type function is not supported by the scanning device 102.

### Third Embodiment

Hereinafter, a third embodiment of the present disclosure is described. In the above-described first and second embodiments, the extension application 204 communicates with the scanning device 102.

In the present embodiment, the general-purpose scanning software 202 communicates with the scanning device 102, and the extension application 204 only executes extension of a scanning command and image editing.

Hereinafter, only a difference between the first and the second embodiments and the present embodiment is described.

### (Scanning Processing Sequence (Extension of Command))

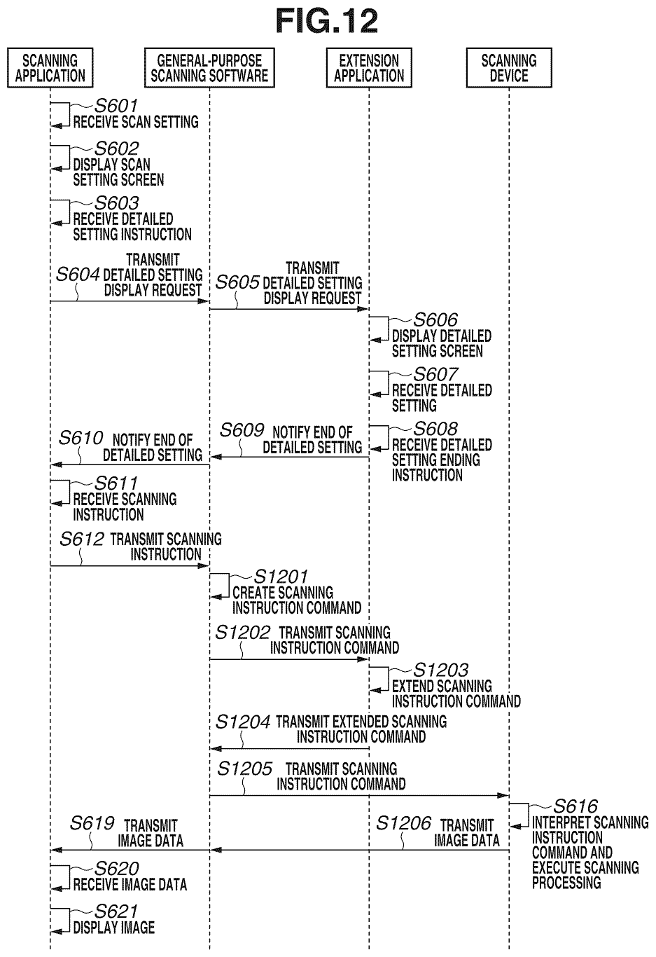

Processing sequence executed by the scanning application 201, the general-purpose scanning software 202, the extension application 204, and the scanning device 102 after the scan setting is received by the scanning application 201 is described with reference to FIG. 12. The same reference numeral is applied to a step common to the step described in FIG. 6, and description thereof is omitted. Further, a point different from the processing illustrated in FIG. 6 is mainly described. The processing in respective steps in FIG. 12, except for the processing executed by the scanning device 102, is implemented by the CPU 111 by executing the scanning application 201, the general-purpose scanning software 202, and the extension application 204 read to the RAM 113 from the external storage device 114. The processing in respective steps executed by the scanning device 102 in FIG. 12 is implemented by the CPU 191 of the scanning device 102, by reading a program stored in the ROM 192 or the external storage device 199 to the RAM 193 and executing the program.

In step S1201, the general-purpose scanning software 202 creates a scanning instruction command. At this time, a function not supported by the general-purpose scanning software 202 is not described in the scanning instruction command.

In step S1202, the general-purpose scanning software 202 transmits the created scanning instruction command to the extension application 204.

In step S1203, the extension application 204 extends the received scanning instruction command by adding an instruction command of a function not supported by the general-purpose scanning software 202 to the scanning instruction command and by changing the existing instruction. In the present embodiment, because the document type setting is not included in the scanning instruction command created by the general-purpose scanning software 202 in step S1201, the extension application 204 adds the document type setting.

In step S1204, the extension application 204 transmits the extended scanning instruction command to the general-purpose scanning software 202.

In step S1205, the general-purpose scanning software 202 instructs the scanning device 102 to execute scanning processing by transmitting the scanning instruction command.

In step S1206, the general-purpose scanning software 202 receives the image data from the scanning device 102.

### (Scanning Processing Sequence (Image Editing))

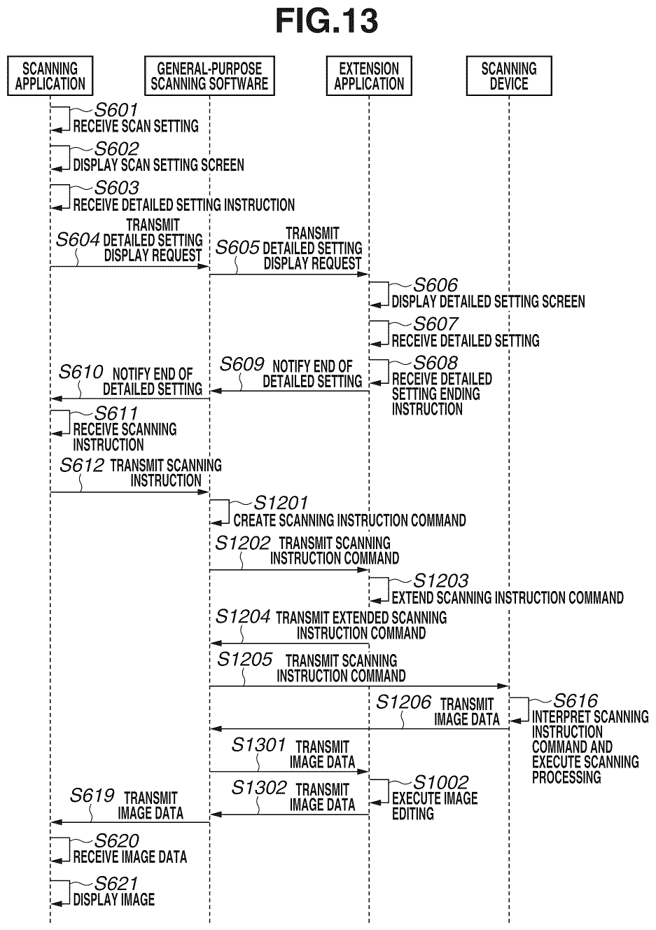

Next, image editing processing executed by the extension application 204 in a case where the general-purpose scanning software 202 communicates with the scanning device 102 is described with reference to FIG. 13. The same reference numeral is applied to a step common to the step described in FIG. 12, and description thereof is omitted. Further, a point different from the processing illustrated in FIG. 12 is mainly described. The processing in respective steps in FIG. 13, except for the processing executed by the scanning device 102, is implemented by the CPU 111 by executing the scanning application 201, the general-purpose scanning software 202, and the extension application 204 read to the RAM 113 from the external storage device 114. The processing in respective steps executed by the scanning device 102 in FIG. 13 is implemented by the CPU 191 of the scanning device 102, by reading a program stored in the ROM 192 or the external storage device 199 to the RAM 193 and executing the program.

In step S1301, the general-purpose scanning software 202 transmits the received image data to the extension application 204.

In step S1002, the extension application 204 executes image editing. In the present embodiment, based on the level 310 of a document type set through the processing similar to the processing in step S1104 of FIG. 11, adjustment according to the document type is executed on the received image data.

In step S1302, the extension application 204 transmits the edited image data to the general-purpose scanning software 202.

As described above, according to the present embodiment, the extension application 204 extends a command with respect to the document type setting, so that the document type function can be implemented by the scanning device 102. Accordingly, the document type function can be provided to the user.

### Fourth Embodiment

Hereinafter, a fourth embodiment of the present disclosure is described. In the above-described first to third embodiments, a command used for a standard protocol is extended, and communication is executed with the scanning device 102.

In the present embodiment, with respect to a function supported by only the extension application 204, communication is executed with the scanning device 102 through another command instead of extending a command used for the standard protocol.

Hereinafter, only a difference between the above-described embodiments and the present embodiment is described.

### (Scanning Processing Sequence (Transmission of Another Command))

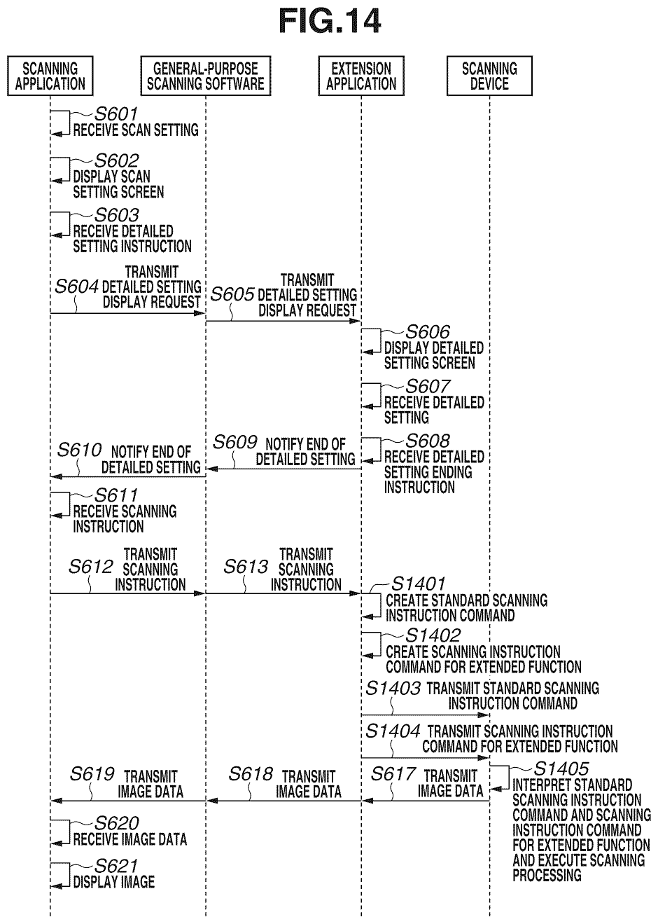

Processing sequence executed by the scanning application 201, the general-purpose scanning software 202, the extension application 204, and the scanning device 102 after the scan setting is received by the scanning application 201 is described with reference to FIG. 14. The processing in respective steps in FIG. 14, except for the processing executed by the scanning device 102, is implemented by the CPU 111 by executing the scanning application 201, the general-purpose scanning software 202, and the extension application 204 read to the RAM 113 from the external storage device 114. The processing in respective steps executed by the scanning device 102 in FIG. 14 is implemented by the CPU 191 of the scanning device 102, by reading a program stored in the ROM 192 or the external storage device 199 to the RAM 193 and executing the program. The same reference numeral is applied to a step common to the step described in FIG. 6, and description thereof is omitted. Further, a point different from the processing illustrated in FIG. 6 is mainly described.

In step S1401, the extension application 204 creates a standard scanning instruction command conforming to the standard protocol. At this time, a function not supported by the standard protocol is not described in the scanning instruction command.

In step S1402, with respect to a function supported by only the extension application 204, the extension application 204 creates a scanning instruction command for an extended function.

In step S1403, the extension application 204 instructs the scanning device 102 to execute scanning processing by transmitting the standard scanning instruction command.

In step S1404, the extension application 204 instructs the scanning device 102 to execute scanning processing by transmitting the scanning instruction command for an extended function.

In step S1405, the scanning device 102 interprets the received standard scanning instruction command and the scanning instruction command for an extended function, and executes scanning processing.

### [Scanning Processing: Extension Application]

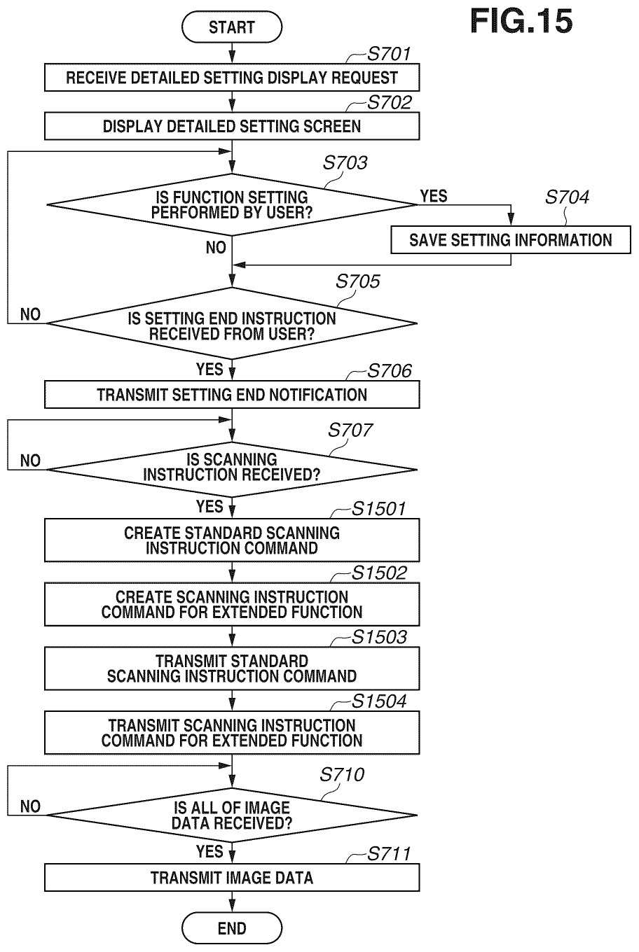

Scanning processing executed by the extension application 204 is described with reference to FIG. 15. Each step is implemented by the CPU 111 by executing each of the units read to the RAM 113 from the external storage device 114. The same reference numeral is applied to a step common to the step described in FIG. 7, and description thereof is omitted. Further, a point different from the processing illustrated in FIG. 7 is mainly described.

In step S1501, the extension application 204 creates a standard scanning instruction command conforming to the standard protocol.

In step S1502, the extension application 204 creates a scanning instruction command for an extended function not supported by the standard protocol.

In step S1503, the extension application 204 transmits the standard scanning instruction command created in step S1501 to the scanning device 102.

In step S1504, the extension application 204 transmits the scanning instruction command for an extended function created in step S1502 to the scanning device 102.

As described above, according to the present embodiment, with respect to a function not supported by the standard protocol, the extension application transmits another scanning instruction command. In this way, the document type function can be provided to the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167863, filed Sep. 26, 2024, which is hereby incorporated by reference herein in its entirety.

What is claimed is:

1. A non-transitory computer-readable storage medium storing an application program that causes an information processing apparatus to perform a control method, the application program being configured to cooperate with general-purpose scanning software commonly usable by image reading devices provided by a plurality of manufacturers, the control method comprising:
displaying an object for receiving a setting related to a type of a document to be read; and
outputting an instruction for reading the document to an image reading device, the instruction being based on the setting received via the object.

2. The non-transitory computer-readable storage medium according to claim 1, wherein the setting about the type of the document is a setting for adjusting a read image according to the type of the document.

3. The non-transitory computer-readable storage medium according to claim 2, wherein the setting about the type of the document includes any one of text, pictures, and text/pictures.

4. The non-transitory computer-readable storage medium according to claim 3, wherein the setting about the type of the document includes a setting for a document intermediate between a text document and a picture document.

5. The non-transitory computer-readable storage medium according to claim 1,
wherein the control method further comprises:
determining whether the received setting about the type of the document is implementable by the image reading device; and
executing processing for adjusting a document type of an image based on the received setting, with respect to scanned and obtained image data, in a case where it is determined that the received setting about the type of the document is not implementable.

6. The non-transitory computer-readable storage medium according to claim 5,
wherein the control method further comprises:
determining whether the received setting about the type of the document is implementable by the image reading device; and
outputting an instruction command excluding a function for adjusting a document type to the image reading device, in a case where it is determined that the received setting about the type of the document is not implementable.

7. The non-transitory computer-readable storage medium according to claim 1,
wherein the control method further comprises transmitting an instruction command of an extended instruction command of a standard protocol, in a case where a reading instruction is issued to the image reading device that executes scanning.

8. The non-transitory computer-readable storage medium according to claim 1,
wherein the control method further comprises transmitting an extended instruction command, in addition to an instruction command of a standard protocol, in a case where a reading instruction is issued to the image reading device that executes scanning.

9. The non-transitory computer-readable storage medium according to claim 1,
wherein the control method further comprises transmitting a unique instruction command without transmitting an instruction command of a standard protocol, in a case where a reading instruction is issued to the image reading device that executes scanning.

10. A control method of an information processing apparatus, wherein general-purpose scanning software commonly usable with image reading devices provided by a plurality of manufacturers and an application program are installed in the information processing apparatus, the application program being configured to cooperate with the general-purpose scanning software, the control method comprising:
displaying an object for receiving a setting related to a type of a document to be read; and
outputting an instruction for reading the document to an image reading device that executes scanning based on the setting received via the object.

11. An information processing apparatus in which general-purpose scanning software commonly usable with image reading devices provided by a plurality of manufacturers and an application program are installed, the application program being configured to cooperate with the general-purpose scanning software, the information processing apparatus comprising at least one processor operating to:
display an object for receiving a setting related to a type of a document to be read; and
output an instruction for reading the document to an image reading device that executes scanning based on the setting received via the object.
